(19) United States
(12) Patent Application Publication
(10) Pub. No.: US 2016/0258596 A1
(43) Pub. Date: Sep. 8, 2016

(54) REFLECTOR AND METHODS OF FABRICATION THEREOF

(71) Applicant: GE Lighting Solutions, LLC, East Cleveland, CA (US)

(72) Inventors: Dengke Cai, Willoughby, OH (US); Tianji Zhao, Highland Heights, OH (US); Mark J. Mayer, East Cleveland, OH (US); Koushik Saha, Strongsville, OH (US); Benjamin James Ward, Beachwood, OH (US)

(21) Appl. No.: 14/634,911

(22) Filed: Mar. 2, 2015

(51) Int. Cl. F21V 7/22; G02B 1/14

(52) U.S. Cl. CPC F21V 7/22; G02B 1/14

(57) ABSTRACT

A reflector that includes a substrate and a film disposed onto the substrate is provided. The film may include gas barrier layers configured to protect a reflective layer included in the film by blocking gas molecules from the top of the reflective layer and gas molecules originating from the bottom of the reflective layer.

### TECHNICAL FIELD

The present disclosure generally relates to reflectors. More particularly, the present disclosure relates to a novel reflector and methods of fabrication thereof.

### BACKGROUND OF THE INVENTION

A high-intensity luminaire is designed to provide sufficient lighting at regions far away from the luminaire. This is achieved using an appropriately shaped reflector disposed adjacent to a high-power light source. This arrangement provides a collimated beam that can illuminate regions distant from the luminaire. For example, a concave reflector may be used to provide a narrow solid angle to which the propagating beam will be confined, thus providing a high degree of directionality.

In order to maximize the degree of directionality of the reflected light, the reflector's reflective surfaces must be smooth; a smooth surface maximizes specular reflection and minimizes diffuse reflectance. As such, the surface roughness of a reflector is a key parameter that directly influences reflectivity.

Furthermore, in high-intensity luminaires, the reflector may absorb a significant amount of heat from one or more light sources included in the luminaire. The absorbed heat may cause structural damage to the reflector. For example, excess heat may lead to the delamination of the reflective film that forms the reflective surfaces. It can also damage the reflector's substrate material, thus degrading performance. Furthermore, at high temperatures, reactive gas molecules, such as oxygen, may attack the reflective surfaces and create hazy spots, which also degrades performance. These molecules may originate from the ambient environment or from outgassing from the substrate.

### SUMMARY

Reflectors designed according to the present disclosure have several advantages that help mitigate the shortcomings described above, in addition to other issues known in the relevant art(s), as will become apparent throughout this disclosure. The exemplary embodiments described have minimal surface roughness, increased thermal stability, all the while providing sufficient protection against outgassing from the substrate and attack from chemical species like oxygen. These features enhance reflection performance and provide increased structural reliability.

In one embodiment, the present disclosure provides a reflector including a substrate and a film disposed onto the substrate. The film includes gas barrier layers configured to protect a reflective layer included in the film by blocking gas molecules originating from the top of the reflective layer and gas molecules originating from the bottom of the reflective layer. The film further includes a top layer configured to protect the reflective layer against mechanical damage.

In another embodiment, the present disclosure provides a reflector including a substrate having an interior surface. The reflector further comprises a reflective surface supported by the substrate, a levelling layer intermediate the interior surface and the reflective surface, the levelling layer comprising a porcelain enamel. The reflector further comprises a gas barrier layer disposed on top of the reflective surface and a protective layer disposed on top of the gas barrier layer.

In yet another embodiment, there is provided a method of fabricating a reflector. The method comprises forming a substrate and disposing a film onto the substrate. The film may include a levelling layer in contact with the substrate. The film may also include a reflective layer. The film further comprises gas barrier layers configured to protect the reflective film from diffusive and reactive species. The film may also include an anti-scratching layer configured to protect the reflective layer from mechanical tearing.

Additional features, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is an illustration of an exemplary luminaire according to an embodiment.

FIG. 2A is an illustration of an exemplary reflector according to the embodiment.

FIG. 2B is an illustration of a cross-sectional view of the reflector of FIG. 2A.

FIG. 3 is an illustration of a cross-sectional view of a reflector according to another embodiment.

FIG. 4 is an illustration of a cross-sectional view of a reflector according to yet another embodiment.

FIG. 5 is an illustration of a method of fabricating a reflector according to an embodiment.

FIG. 6 is an illustration of a method of fabricating a reflector according to another embodiment.

### DETAILED DESCRIPTION OF THE DRAWINGS

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

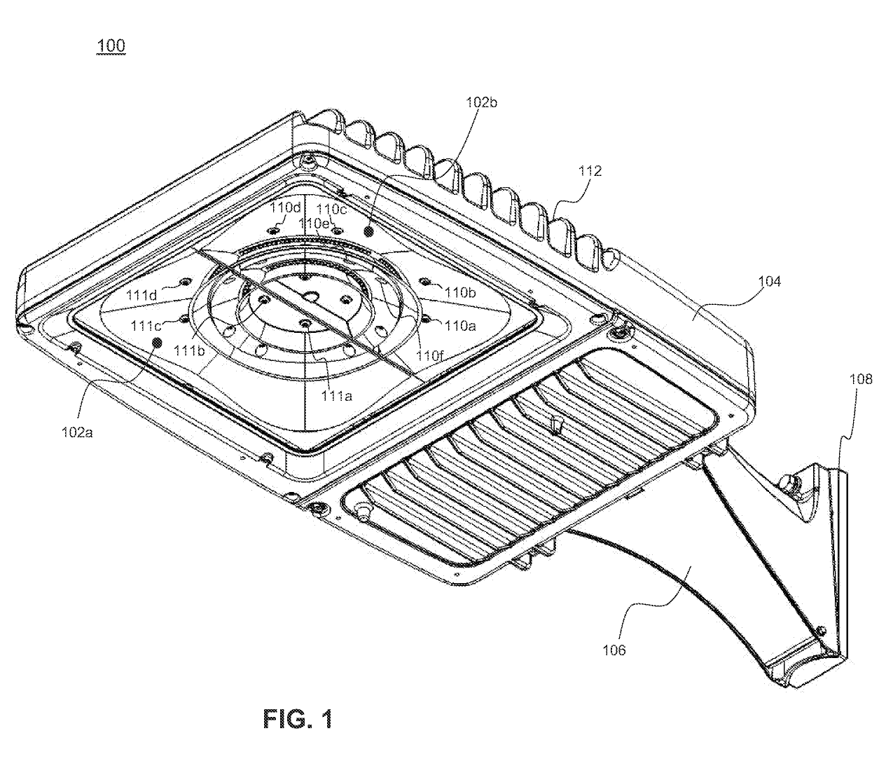

FIG. 1 is an illustration of a luminaire 100 according to an embodiment. Luminaire 100 includes a support beam 106 that is affixed to a wall fixture 108, thus permitting the luminaire to be mounted on a wall. Further, luminaire 100 may have a fin 112 mounted on a dorsal portion of the luminaire's body 104. Fin 112 may include corrugations or the like. Generally speaking, fin 112 serves to passively dissipate the heat generated by light sources (not shown) comprised in luminaire 100.

The light sources of luminaire 100 include high-intensity discharge (HID) lamps, light-emitting diodes (LEDs), incandescent light sources, or the like. Luminaire 100 also includes reflectors 102a and 102b. Reflectors 102a and 102b are affixed to an inner surface (not shown) of the body 104 of luminaire 100. Specifically, reflectors 102a and 102b are mounted to the inner surface of body 104 using means 110a-110f and 111a-111d. One of ordinary skill in the art will readily appreciate that any suitable means may be used to secure reflectors 102a and 102b onto the inner surface of body 104. For example, screws, clamps, pins, and fasteners are all examples of devices that can be used for that purpose.

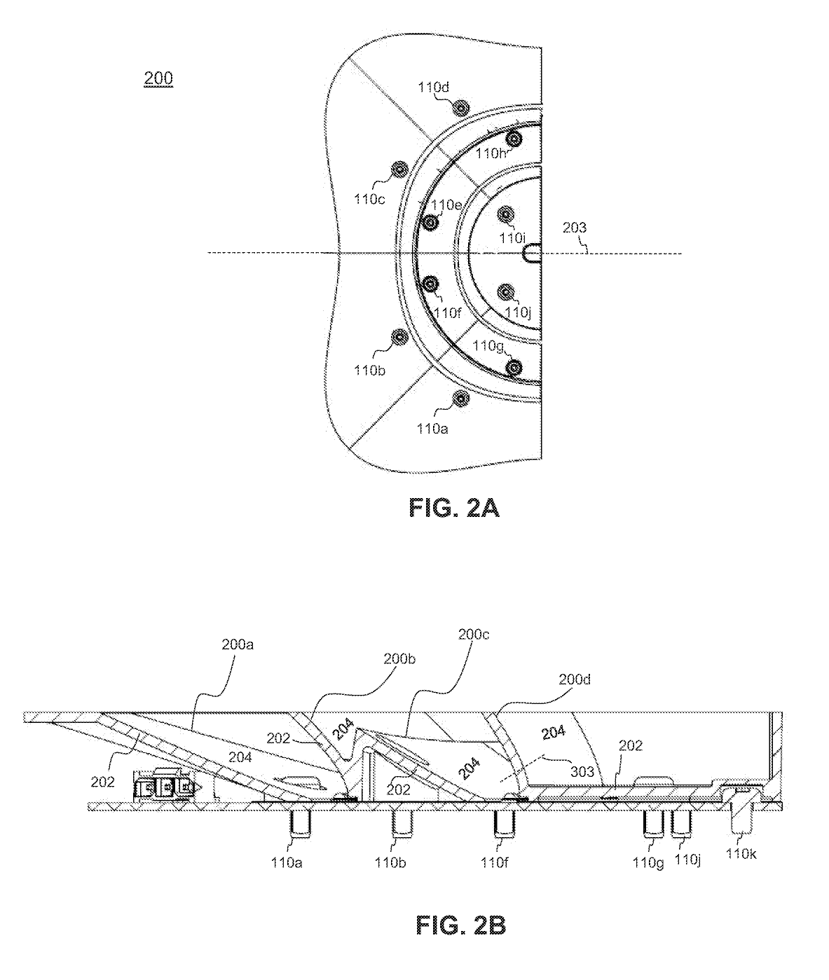

FIG. 2A is an illustration of one of the reflectors of luminaire 100, namely, reflector 102a, for example. Reflector 102a may be mounted to the body 104 of luminaire 100 using at least means 110a-110i. FIG. 2B is an illustration of a cross-sectional view 200 of reflector 102a along line 203 shown in FIG. 2A. As illustrated in FIG. 2B, reflector 102a includes several pieces (200a-200d) secured to body 104 using at least means 110a, 110b, 110g, 110f, 110g, 110j, and 110k. In some embodiments, reflector 102a may be made of a single piece unlike in the illustration of FIG. 2B. In other embodiments, reflector 102a may include more or fewer pieces than those shown in FIG. 2B.

Each of piece 200a-200d includes a substrate 202 on top of which is a disposed a film 204, having a highly reflective surface. In some embodiments, the reflectance of film 204 is in the range of about 90% to about 98%. In other embodiments, the reflectance of film 204 is in the range of about 80% to about 95%. Yet in other embodiments, the reflectance of film 204 is in the range of about 65% to about 95%. One of ordinary skill in the art will readily appreciate that any given reflectance can be achieved without departing from the scope of the present disclosure.

In each of piece 200a-200d, substrate 202 may be made of aluminum or another metal. For example, the substrate 202 of piece 200a can be a die cast aluminum member fabricated with a predetermined shape and curvature. In some embodiments, the film 204 disposed on the metal substrate 202 includes, in ascending direction from the substrate 202, a porcelain layer, a silver layer, a gas barrier layer, and an anti-scratching layer.

In other embodiments, the film 204 can include, in ascending direction from the substrate 202, a porcelain layer, an adhesion layer, a silver layer, a gas barrier layer, and an anti-scratching layer. Each of the afore-mentioned layers includes at least two layers that together accomplish the desired functionality. For example, the gas barrier layer includes layers that cooperatively function as a gas barrier layer.

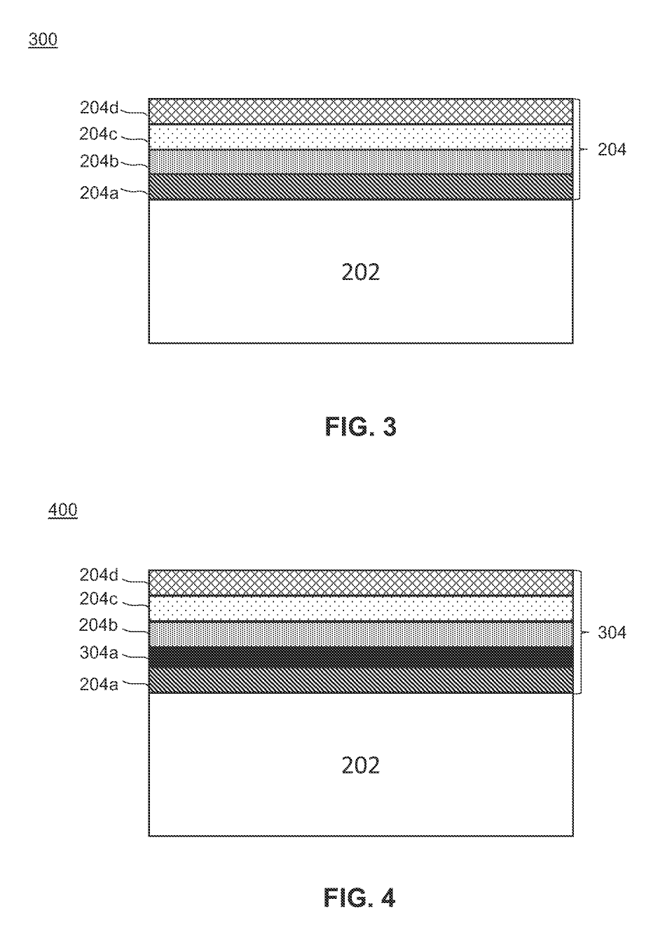

FIG. 3 is an illustration of a cross-sectional view 300 of one of the pieces 200a-200d. Each of pieces 200a-200d includes a substrate 202 and a film 204. Film 204 includes several layers described below. For the sake of clarity, the following descriptions are provided for piece 200d along line 303, as shown in FIG. 2B. However, the same description applies to the other pieces. Furthermore, the layers of FIG. 3 are not drawn to scale, but one of ordinary skill in the art will readily recognize that their absolute thicknesses as well as their relative thicknesses may vary from one embodiment to another.

As previously mentioned, substrate 202 may be made of aluminum. It can also be made of steel. The surface of substrate 202 onto which layer 204a is disposed may be rough. Surface roughness relates to the presence of peaks and valleys within a surface, indicating the surface is not flat. Varying degrees of surface roughness are achievable, depending on the fabrication method of the aluminum substrate. An average measure of surface roughness can be calculated using the surface's height variation on a segment of the surface, thus yielding a line profile of the surface.

Alternatively, a measure of roughness can be calculated using the height variation in a selected area, thus yielding an area profile. The line profile is measured using a stylus profilometer whereas the area profile is obtained using an optical profilometer, such as an interferometric profilometer.

An arithmetic average of the heights measured along the line profile can be used to calculate an average surface roughness metric. Similarly, an arithmetic average of the heights measured in the area profile can be used to compute the average surface roughness metric. By way of example only, and not limitation, the surface roughness metric can be 5 micrometers. That is, on average peaks having 5 micrometer height can be found throughout the surface. As such, to level the surface and remove the roughness, the thickness of layer 204a may be twice or three times the surface roughness metric. Thus, layer 204a acts as a levelling film, providing a flatter surface onto which the reflective material is disposed, as explained below.

Layer 204a can be formed of porcelain, or simply a porcelain enamel. In one embodiment, the porcelain enamel includes a fused mass of glass-forming materials. The glass forming materials are primarily present as components of oxides compounds, but some can be present as halides, chalcogenides, in multiple oxidation states, or in more complex compounds. Exemplary oxides include alkali metal oxides, alkaline-earth metal oxides, transition element oxides, and oxides of silicon and aluminum. The oxides can include one or more of Al, Si, Ti, V, Ba, K, B, Li, P, Mg, Na, Mo, Zn, La, Y, Nb, Zr, Sb, Sn, In, Cr, Fe, Mn, Cu, Ni, Co, Ce, and Pb. In some embodiments, layer 204a is substantially comprised of oxides, such as those listed above and may comprise a total of at least 5% of oxides of titanium and vanadium.

Layer 204a may be disposed on substrate 202 as follows. Powdered precursor ingredients that form the above-mentioned oxides are melted and poured into cold water in their molten state. This process produces a friable glass, namely, a “frit.” The frit is ground in a mill until finely powered and mixed with water to produce a spraying mixture.

The resulting mixture is spray-coated onto substrate 202 at a desired thickness that permits levelling the interior surface of substrate 202, as discussed above. The coated substrate 202 is placed in an oven where the temperature is adjusted to sinter layer 204a to form a solid film. Sintering of the porcelain enamel is desirably achieved at a temperature that is below the softening point of the metal substrate 202. As such, in the case of substrate 202 being made of aluminum, sintering the porcelain occurs at a temperature of about 650 degrees Centigrade. In other embodiments, sintering the porcelain occurs at a temperature of about 600 degrees Centigrade. Furthermore, when substrate 202 is made of steel sintering the porcelain occurs at a temperature in the range of about 800 degrees Centigrade and about 850 degrees Centigrade.

In addition to providing a sintering temperature compatible with the softening point of substrate 202, layer 204a, upon solidification, has a matched coefficient of thermal expansion (CTE) with layer 204a and substrate 202. As such, there is a lower risk of delamination when reflector 102a is subject to intense radiative heat or convective heat. Furthermore, layer 204a dissipates heat evenly across its surface regardless of the light source's radiation profile. For example, in the case of high power LEDs, which typically have a Lambertian radiation profile, layer 204a spreads the absorbed heat evenly across its surface and cross-section, providing improved and uniform heat dissipation.

Layer 204b is desirably disposed directly atop layer 204a, with no intervening layers. Layer 204b, for example, can be silver. By way of example, silver can be deposited onto layer 204a using a D.C. magnetron sputtering process in an argon plasma environment. Other silver deposition methods are contemplated, such as, for example, e-beam evaporation, resistive evaporation, electroplating, or autocatalytic deposition methods. Additionally, while layer 204a is made of silver in the example above, trace elements introduced during the deposition process can remain in layer 204b upon deposition completion. As such, layer 204b can be at least 95% pure silver.

Layer 204b is highly reflective and does not conform to the morphology of substrate 202 since the underlying layer 204a levels the interior surface of substrate 202. As such, layer 204b is a flat surface that circumvents surface roughness problems that lead to unwanted diffused reflectance.

Layer 204c can be a protective coating disposed on the reflective silver coating, i.e. layer 204b. For example, layer 204c can delay or prevent the diffusion of oxidizing or reactive chemicals that can tarnish the reflective silver surface (i.e. layer 204b).

Thus, layer 204c functions as a gas barrier layer that can be deposited by evaporation, sputtering, or chemical vapor deposition. In some embodiments, layer 204c may be thinner than layer 204b. Layer 204c may be formed using a sol-gel or another type of SiO₂ precursor to form a continuous sub-micrometer to few-micrometer hybrid SiO₍₂₋ₓ₎ layer, where 0<x<2 layer, i.e. a silicon sub-oxide.

Layer 204d can be an anti-scratch coating including an organic material. In some embodiments, layer 204d, can be silica or a sub-oxide of silicon, i.e. an inorganic layer, although it can be formed from an organosilicon precursor. The layer 204d can also include a polymer material such as a non-nano filler polymer. Alternatively, the polymer coating can be a nano-filler polymer. Non-nano filler polymer coatings can be urethane-based. These types of coatings have increased optical and mechanical stability at relatively low temperatures. In other embodiments, to ensure optical and mechanical stability at relatively high temperatures, a nano-filler polymer material may be used.

A nano-filler polymer may be a polymer in which there are embedded particulates of an inorganic material, thus forming a composite film. The particulates may have nanometer size. They may have the shape of tubules, dots, or they may have lamellar morphology. One of ordinary skill in the art will readily recognize that particulates with any shapes are contemplated.

Further, some particulates may have sizes that extend beyond the nanometer scale. For example, the size of one or more particulates may be on the order of micrometers. Furthermore, the particulates may be embedded into the polymer at a concentration that equals or exceeds a percolation threshold. In other embodiments, the particulates may be embedded into the host polymer at a concentration below the percolation threshold.

In some embodiments, the polymeric material may be one of a siloxane-based polymer, an acrylic-based polymer, poly-methyl methacrylate, and a styrene-acrylic co-polymer. In the case of nano-filler polymers as the host organic material for layer 204d, the particulates may be selected from the group consisting of SiO₍₂₋ₓ₎ where 0<x<2, ZrO₂, TiO₂, TiO₂-coated SiO₍₂₋ₓ₎, and Al₂O₃. The non-nano filler polymer or the nano-filler polymer can be treated to provide a hydrophobic surface. Hydrophobic surfaces have the advantages of increasing protection for the underlying layers by preventing moisture absorption. Hydrophobicity (or the degree of hydrophilicity) can be tuned by altering the surface tension exerted on water molecules when adsorbing onto layer 204d

Layer 204d also provides mechanical protection, i.e. protection against mechanical tearing. Specifically, layer 204d is substantially immune to scratches, ensuring the reflective film (layer 204b) does not suffer damage, permitting the maintenance of high reflectivity.

Layer 204d has the aforementioned advantages without compromising optical performance. For example, in some embodiments, layer 204d may have at least 85 to 90% transmittance.

FIG. 4 is an illustration of a cross-sectional view 400 of one of the pieces 200a-200d. For the sake of clarity, the following description is provided with respect to piece 200d, along line 303 shown in FIG. 2B. The exemplary embodiment of FIG. 4 is similar to the embodiment of FIG. 3. The same considerations apply, for layers having the same reference numerals as in FIG. 3. However, the exemplary embodiment depicted in FIG. 4 includes an additional gas barrier layer. This means that film 304 differs structurally from film 204 simply by the addition of another gas barrier layer than layer 204c.

Reflector piece 200d includes a layer 304a between the porcelain layer 204a and silver layer 204b to promote adhesion of the silver and/or prevent outgassing of water or other chemicals from the substrate. This outgassing can result in a hazy appearance and loss of reflective performance. Layer 304a is formed of a material compatible with porcelain such as silica. An exemplary deposition method includes plasma-enhanced chemical vapor deposition (PECVD) using a precursor of hexamethyldisiloxane (HMDSO). The deposited silica may be fully oxidized SiO₂ or a sub-oxide of silicon, namely, SiO₍₂₋ₓ₎.

By way of example, and not by limitation, thicknesses of the various layers described above are provided. Referring to FIG. 3, the thickness of layer 204a can be in the range of about 25 micrometers to about 50 micrometers. Layer 204b can be in the range of about 2000 Angstroms to about 2500 Angstroms. Layer 204c can be in the range of about 250 Angstroms to about 500 Angstroms. Layer 204d can be in the range of about several hundreds of Angstroms to about 10,000 Angstroms. Referring to FIG. 4, layer 304a may be as thin as 20 Angstroms. It should be appreciated that other thicknesses may be used, depending on the embodiment. Further, in some embodiments, the relative thickness of the layers may be maintained as described above, even when the absolute thickness of each layer is different from the values and ranges provided.

Having set forth the structures consistent with several exemplary embodiments, we now turn to the advantages that are not existent in the relevant related art(s) but readily gained from practicing the teachings disclosed herein. Embodiments of the present disclosure may include a reflective silver film deposited on a porcelain-coated die cast aluminum layer with strong adhesion to the porcelain and with a sub-micrometer to micrometer-thick SiO₍₂₋ₓ₎ protective layer on top of the reflective film.

Embodiments of the present disclosure have several advantageous features. The wet-processed porcelain described above provides appropriate sintering temperature to match the softening point of the metal substrate. Moreover, the formed porcelain minimizes the surface roughness of the metal substrate by providing a relatively flat surface morphology onto which subsequent layers may be deposited. Thus, by ensuring flatness, the embodiments provide a high quality reflector with negligible diffuse reflectance and increased specular reflectance. Additionally, the applied porcelain matches CTE with silver and the substrate. Furthermore, the applied porcelain can withstand temperatures in the range of about 150-200 degrees Centigrade.

The embodiments also provide a simplified reflector structure including only inorganic materials that provide uniform heat dissipation, improved thermal stability and mechanical reliability. The simplified structure results in lower manufacturing costs.

Yet another advantage is protection from diffusing reactive species that can degrade the reflector's structural integrity and optical performance. For example, some embodiments provide protection from diffusing gas molecules such as oxygen, into the reflective silver layer, from the top of the reflector using a first gas barrier layer. Additionally, a second gas barrier layer can protect from the uptake of outgassing species originating from the bottom of the reflective film.

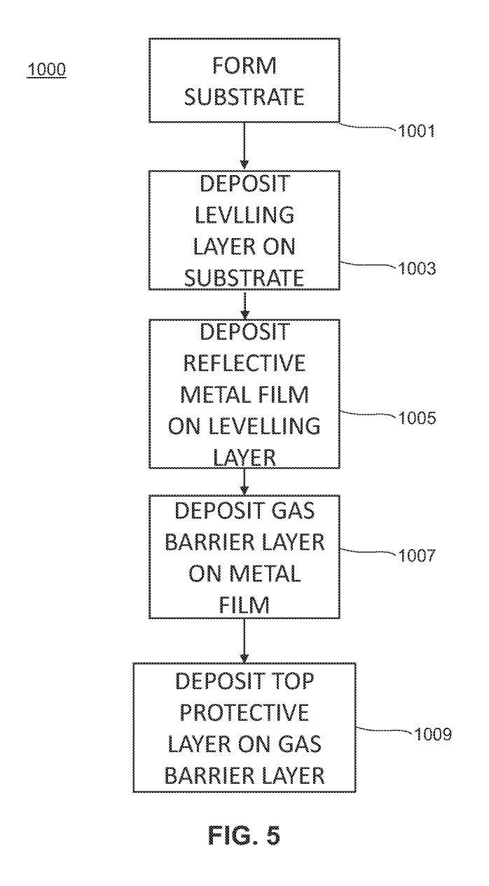

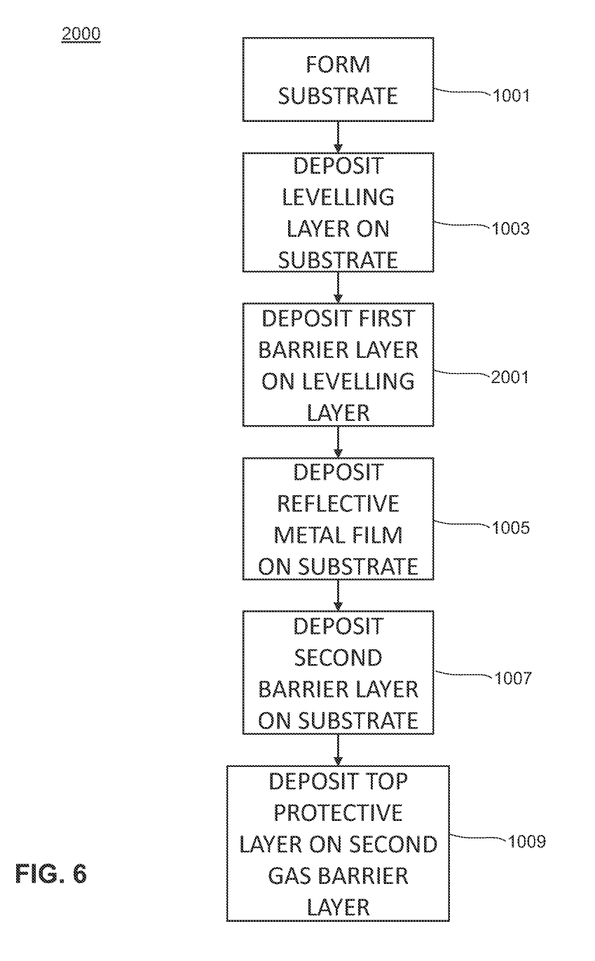

FIG. 5 and FIG. 6 are exemplary methods of fabricating the reflectors depicted in FIGS. 3 and 4, respectively. It should be understood that some intermediary steps that are well-known in the art are omitted for the sake of clarity. Such an intermediary step may be, for example, the cleaning of substrate 202 and/or an isotropic finishing process on substrate 202 that serves as a first step towards minimizing the surface roughness of substrate 202. One of ordinary skill in the art will readily appreciate that the inclusion (or omission) of these intermediary steps does not depart from the scope of the exemplary fabrication methods disclosed herein.

FIG. 5 illustrates a method 1000 of fabricating a reflector, according to an embodiment. Such a reflector may be like the reflectors discussed previously in the context of FIGS. 2A, 2B, and 3. Method 1000 begins by forming a substrate (step 1001). The substrate may be a metal. The metal substrate may be aluminum or substantially aluminum. As understood by one of ordinary skill in the art, a substrate of less than 100% pure aluminum can also be used.

The metal substrate can be formed according to a predefined shape, and can have a predefined curvature. For example, the substrate can be parabolic. The substrate can also have a predefined average surface roughness parameter in accordance with an upper-bound, or a predetermined tolerance. In one example, the substrate may be a die-cast aluminum substrate.

Method 1000 further includes depositing a levelling layer onto the substrate (step 1003). The levelling layer may be a porcelain enamel (step 1003) obtained, for example, using a wet porcelain process. The porcelain layer can be spray-coated onto the substrate and fused into an enamel by thermally cycling the coated substrates at a maximum temperature not exceeding the substrate's softening point. For an aluminum substrate, the porcelain layer is fused at a temperature less than or equal to about 650 degrees Centigrade.

The method 1000 also includes depositing a reflective metal layer (step 1005) that can be formed, for example, of silver. The silver layer may be deposited using a sputtering process at a predetermined thickness. Method 1000 can include depositing a gas barrier layer (step 1007) onto the metal layer using evaporation, sputtering, chemical vapor deposition, and the like. The gas barrier layer can be formed using a sol-gel or another type of SiO₂ precursor to form a continuous sub-micrometer to few-micrometer hybrid SiO₍₂₋ₓ₎, where 0<x<2 layer, i.e. a silicon sub-oxide. One of ordinary skill in the art will readily understand that parameters such as precursor concentration, deposition pressure, and the like may be varied to alter the stoichiometry of the sub-oxide, i.e. to obtain a sub-oxide having a predetermined stoichiometric value for x.

Method 1000 also includes disposing a top protective layer on the top the gas barrier layer (step 1009). This top protective layer can be inorganic and deposited using processes similar to those described above with respect to the gas barrier layer. The gas barrier layer and the protective layer can be formed of a silicon sub-oxide. In other embodiments, the protective layer can be a polymer, or a polymer filled with inorganic nanostructures. This protective layer, i.e. a nano-composite can be deposited onto the gas barrier layer via spin-coating, followed by a thermal cycle that cures the polymer. Alternatively, spray-coating process could be used.

FIG. 6 is an illustration of exemplary method 2000 of fabricating a reflector. Such a reflector can be similar to the reflectors discussed above. Additionally, the method 2000 is similar to method 1000. As such, the same considerations apply, for steps having the same reference numerals as in method 1000. The method 2000 includes depositing an additional gas barrier layer, namely at step 2001. The step 2001 can include the same or similar deposition processes, similar to those described with respect to step 1007 in method 1000. It should be appreciated, however, that the two gas barrier layers may or may not have the same structures and/or thicknesses.

While the embodiments, structures, and methods disclosed herein are described in the context of specific material systems, the present disclosure is not limited thereto. Specifically, a reflective metal layer other than silver can be used. For example, aluminum, copper or gold can be used as a reflective material. Additionally, the porcelain layer can vary in content from one embodiment to another. Alternatively, a levelling layer other than porcelain can be used, as long as the layer has adhesion properties and thermal properties compatible with the other materials used, as described above in the exemplary embodiments. Furthermore, while the embodiments have been described in the context of reflectors for luminaires, the present disclosure is not limited thereto and other applications in which high performance reflectors are needed are also contemplated.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A reflector, comprising:
a substrate;
a multilayer film disposed onto the substrate;
wherein the multilayer film includes (i) gas barrier layers configured to protect a reflective layer included in the film by blocking gas molecules originating from the top of the reflective layer and gas molecules originating from the bottom of the reflective layer; and (ii) a top layer configured to protect the reflective layer against mechanical tearing.

2. The reflector of claim 1, wherein the multilayer film comprises a porcelain enamel layer in contact with the substrate.

3. The reflector of claim 1, wherein at least one of the gas barrier layers is a silicon sub-oxide.

4. The reflector of claim 1, wherein the reflective layer substantially comprises silver.

5. The reflector of claim 1, wherein the top layer is an anti-scratching layer.

6. A reflector, comprising:
a substrate having an interior surface;
a reflective surface supported by the substrate;
a levelling layer intermediate the interior surface and the reflective surface, the levelling layer comprising a porcelain enamel;
a gas barrier layer disposed on top of the reflective surface; and
a protective layer disposed on top of the gas barrier layer.

7. The reflector of claim 6, further comprising another gas barrier layer disposed on top of the levelling layer.

8. The reflector of claim 6, wherein the porcelain enamel comprises a fused mixture of one or more oxides.

9. The reflector of claim 6, wherein the substrate is a metallic substrate.

10. The reflector of claim 6, wherein all the layers comprised therein are made of inorganic compounds.

11. The reflector of claim 6, wherein all the layers comprised therein include inorganic compounds.

12. The reflector of claim 6, wherein at least one layer includes an organic material.

13. The reflector of claim 12, wherein the at least one layer is a polymeric material.

14. The reflector of claim 13, wherein the polymeric material has inorganic particulates embedded therein.

15. A method of fabricating a reflector, comprising:
forming a substrate; and
disposing a film onto the substrate, the film comprising a levelling layer in contact with the substrate, and the film comprising a reflective layer;
wherein the film further comprises gas barrier layers configured to protect the reflective film from diffusive and reactive species and an anti-scratching layer configured to protect the reflective layer from mechanical tearing.

16. The method of claim 15, wherein the substrate is a metallic substrate.

17. The method of claim 15, wherein the levelling layer is a porcelain enamel.

18. The method of claim 15, wherein the reflective layer is substantially made of silver.

19. The method of claim 15, wherein one of the gas barrier layers is a based on a silicon oxide.

20. The method of claim 15, wherein the film further comprises an anti-scratching layer.
